(19) United States
(12) Patent Application Publication
(10) Pub. No.: US 2025/0376556 A1
(43) Pub. Date: Dec. 11, 2025

(54) Curable Epoxy Resin Compositions with High Glass Transition Tempature

(71) Applicant: Huntsman Advanced Materials Americas LLC, The Woodlands, TX (US)

(72) Inventors: Kevin Wacker, The Woodlands, TX (US); Dong Le, The Woodlands, TX (US); Derek Kincaid, The Woodlands, TX (US)

(21) Appl. No.: 18/873,786

(22) PCT Filed: Jun. 19, 2023
(86) PCT No.: PCT/US2023/025658

§ 371 Date: Dec. 11, 2024

Related U.S. Application Data
(60) Provisional application No. 63/356,135, filed on Jun. 28, 2022.

(51) Int. Cl. C08G 59/32; C08G 59/50

(52) U.S. Cl. CPC C08G 59/3227; C08G 59/506

(57) ABSTRACT

The present invention relates to curable epoxy resin compositions comprising an alkyl-substituted aromatic epoxy resin and a bis alicyclic amine hardener, which when cured exhibit preferred chemical and physical characteristics. The present invention also relates to the use of such curable resin compositions which may be cured in the presence of reinforcing fibers to form fiber-reinforced composite articles used in a variety of applications, such as in transport applications (including aerospace, aeronautical, nautical and land vehicles, and including the automotive, rail, coach and military industries), in building/construction applications or in other commercial applications, and to aerospace structural parts made from the fiber-reinforced composite articles.

### CROSS-REFERENCE TO RELATED APPLICATION

This application claims priority to U.S. Provisional Application No. 63/356,135 filed Jun. 28, 2022. The noted application(s) is incorporated herein by reference.

### FIELD OF THE INVENTION

The present invention is directed to a curable epoxy resin compositions comprising an alkyl-substituted aromatic epoxy resin and a bis alicyclic amine hardener, which when cured exhibit preferred chemical and physical characteristics. In particular, the cured epoxy resin compositions of the present invention demonstrate a high glass transition temperature. The present invention also relates to the use of such curable resin compositions which may be cured in the presence of reinforcing fibers to form fiber-reinforced composite articles used in a variety of applications, such as in transport applications (including aerospace, aeronautical, nautical and land vehicles, and including the automotive, rail, coach and military industries), in building/construction applications or in other commercial applications, and to aerospace structural parts made from the fiber-reinforced composite articles.

### BACKGROUND OF THE INVENTION

Curable resin compositions containing epoxy resins are used in a number of processes to form structural composites. Especially, curable resin compositions containing an aromatic epoxy and an amine component achieving high glass transition temperatures are used to form structural composites being able to resist deformation and loss of mechanical properties in high temperature applications. Structural composites used in high temperature applications could include primary and secondary aerospace structural materials (wings, fuselages, bulkheads, flap, aileron, cowl, fairing, interior trim, etc.), rocket motor cases, and structural composites for artificial satellites. Examples of automotive structural composites include vertical and horizontal body panels (fenders, door skins, hoods, roof skins, decklids, tailgates and the like) and automobile and truck chassis components.

To form structural composites, such compositions may be used in molding processes including those known as resin transfer molding (RTM), vacuum-assisted resin transfer molding (VARTM), Seeman Composites Resin Infusion Molding Process (SCRIMP), reaction injection molding (RIM) processes and liquid compression molding (LCM). In each of these processes, the curable resin composition is applied to a reinforcing agent and cured in the presence of the reinforcing agent. A composite is then formed having a continuous polymer phase (formed from the cured resin) in which the reinforcing agent is dispersed.

The various processes above can be used to produce a wide range of products. For instance, the molding processes (such as RTM, VARTM, SCRIMP, RIM and LCM) can be used to produce high strength parts useful, for example, in automobile and aircraft components. In the RTM, VARTM and SCRIMP processes, the part is formed by inserting a woven or matted fiber preform into a mold cavity, closing the mold, injecting the resin into the mold and hardening the resin. In the RIM process, the woven or matted fiber preform may be inserted in the mold beforehand as just described, or it can be injected into the mold together with the curable resin composition. In the LCM process, the reactive mixture is applied directly to a fiber preform or stack without injection, but by spraying or by laying it down as “bands” of system, which are being fed through a wider slit die having a width of 1 cm to 50 cm or more.

As is the case with many other manufacturing processes, the economics of these composite manufacturing processes is heavily dependent on operating rates. For molding processes, operating rates are often expressed in terms of “cycle time”. Cycle time refers to the time required to produce a composite part in the mold and prepare the mold to make the composite part. Cycle time directly affects the number of composite parts that can be made on a mold per unit time. Longer cycle times increase manufacturing costs because overhead costs (facilities and labor, among others) are greater per part produced. For these reasons, there is often a desire to shorten cycle times.

When a curable composition with a high glass transition temperature is used in the molding processes described above, the predominant component of cycle time is the amount of time required for the resin to cure. For curing a resin composition comprising an aromatic epoxy and an amine component, also called amine hardener, that achieves a high glass transition temperatures of above 200 degrees, it is well known to use high cure temperatures ranging from 180° C. to 220° C. In addition, after such type of resin composition has cured, a post cure treatment at a higher temperature than the cure temperature is often required to achieve the targeted high glass transition temperature.

In addition, in the case of such resin composition comprising an aromatic epoxy and an amine hardener, higher glass transitions are often achieved when both the epoxy and the hardener contain more aromatic (as opposed to aliphatic) molecular structures. WO2021083583, WO2019177131 and US20210292545 describe different combinations of aromatic epoxy resins and aromatic amine components wherein the cure temperature of said combinations ranges from 180° C. to 220° C. in order to achieve a glass transition temperature of 200° C. to 280° C.

However, long cure times for such resin compositions with a high glass transition temperature are often required, especially if a post cure treatment is required at higher temperature. There is thus a need for a curable epoxy composition used to form structural composites being able to resist deformation and loss of mechanical properties in high temperature applications wherein its high glass transition temperature is obtained during the molding process itself (i.e., without the need for an additional post-curing step).

Additionally, structural composites in high temperature applications such as engine and nacelle components including cowlings or thrust reversers, and leading edges of wings or rockets, must keep their properties under high thermal and mechanical stress. It is thus targeted to have cured epoxy composition with a glass transition temperature of at least 300° C. in order to operate safely with structural composites made from said cured epoxy compositions at temperatures of 170° C. or higher and avoid part failure of said structural composites when exposed to high thermal and mechanical stress.

To achieve a glass transition temperature of at least 300° C., the cure or post cure temperature must typically be of at least 200° C., often greater than 220° C., leading to a longer cure time than the classic epoxy resin that are usually cured at 180° C. In fact, it is widely known that it is difficult to achieve a glass transition temperature at least 100° C. higher than the highest cure or post cure temperature. There is further a need for a curable epoxy composition having all the properties above-mentioned achieving a high glass transition temperature with a conventional cure temperature, i.e a cure temperature of 180° C.

Furthermore, it is widely known that it is difficult to achieve high glass transition temperatures when implementing standard cure cycles with liquid molding processes as VARTM described above. Standard vacuum bagging materials used in VARTM are not amenable to cure cycles requiring high cure temperatures above 200 or 220° C. and therefore specialty process materials including release films, sealant tapes, breathers and vacuum bags are needed. Additionally, high cure temperatures will affect heat management in the mold, fiber, resin, and process materials. High cure temperatures may not allow proper release of heat generated during the curing process leading to exotherms or altered cure temperature needed to achieve the cured epoxy composition with a high glass transition temperature. These exotherms or mismanagement of heat during high cure temperatures can result in scrapping or rejection of the final part. There is a further need for a curable epoxy composition having all the properties above mentioned that can achieve a high glass transition temperature when cured with liquid molding process such as VARTM at standard cure temperatures of 180° C.

### SUMMARY OF THE INVENTION

The present invention relates to a curable epoxy resin composition comprising:
(a) an alkyl-substituted aromatic epoxy resin of the general formula (I):

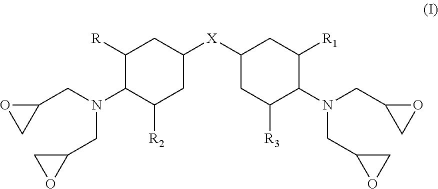

where
   each of R and R₁ independently is methyl, ethyl or isopropyl,
   each of R₂ and R₃ independently is hydrogen, methyl, ethyl or isopropyl,
   X is —O—, —S—, —CO—, —C(═O)O—, —NHCO—, —SO₂—, a linear or branched alkyl, a substituted or unsubstituted cycloalkyl, a substituted or unsubstituted aromatic residue, or a substituted or unsubstituted heterocycle; and
(b) a bis alicyclic amine hardener of the general formula (II):

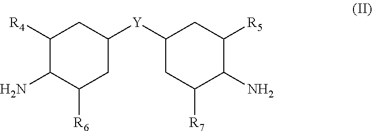

where
   each of R₄ and R₅ independently is hydrogen, methyl, ethyl or isopropyl,
   each of R₆ and R₇ independently is hydrogen, methyl, ethyl or isopropyl,
   Y is —O—, —S—, —CO—, —C(═O)O—, —NHCO—, —SO₂—, a linear or branched alkyl, or a substituted or unsubstituted cycloalkyl.

The above components, when provided in a composition, unexpectedly yields, upon curing, a cured epoxy resin which exhibits a high glass transition temperature of at least 300° C.

### DETAILED DESCRIPTION OF THE INVENTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical object of the article. By way of example, “an epoxy” means one epoxy or more than one epoxy.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The present disclosure is generally directed to novel epoxy resin compositions which comprise an alkyl-substituted aromatic epoxy resin and a bis alicyclic amine hardener and structural composites obtained with such compositions. It has been surprisingly found that the specific combination of an alkyl-substituted aromatic epoxy resin and a bis alicyclic amine hardener produces with conventional cure temperature, an epoxy resin exhibiting improved glass transition temperatures, for example, a glass transition temperature of at least about 300° C. without a substantial loss in toughness. Such properties may be used to generally define a noticeably improved composition according to this invention. As used herein, the phrase “glass transition temperature” (abbreviated “Tg”) means the temperature at which the mechanical properties of a material (e.g., a cured resin) radically change due to the internal movement of the polymer chains that form the material. As used herein the term “hardener” means a component that reacts with the epoxy resin to allow the epoxy composition to harden into a solid material, i.e. the cured epoxy composition. According to the invention, the bis alicyclic amine hardener is different than an amine catalyst, which may also affect the curing of an epoxy composition but by a different mechanism than the bis alicyclic amine hardener.

According to one particular embodiment, the specific combination of an alkyl-substituted bis aromatic glycidyl amine and an (alkyl-substituted) bis cyclohexylamine hardener provides an epoxy resin composition to form, upon curing, a cured epoxy resin exhibiting an improved glass transition temperature. As used herein, the term “improved glass transition temperature” is intended to refer to a cured epoxy resin whose glass transition temperature has been increased through application of the present disclosure as compared to conventional resins. Furthermore, the term “epoxy resin composition” or “curable epoxy resin composition” is intended to refer to an uncured composition, which upon curing, cures to a “cured epoxy resin” or “cured product.” The term “curable” means that the composition is capable of being subjected to conditions which will render the composition to a cured state.

According to one embodiment, the alkyl-substituted aromatic epoxy resin of the general formula (I) has:
each of R and R₁ independently is methyl, ethyl or isopropyl,
each of R₂ and R₃ independently is hydrogen, methyl, ethyl or isopropyl,
X is —O—, —S—, —CO—, —C(═O)O—, —NHCO—, —SO₂—, a linear or branched alkyl having 1 to 6 carbon atoms, a substituted or unsubstituted aromatic residue, or a substituted or unsubstituted heterocycle.
   Examples of linear or branched alkyl having 1 to 6 carbon atoms include —CH₂—, —C(H)(CH₃)—, —C(CH₃)₂—, —C(H)(CH₂CH₃)—, —C(H)(CH(CH₃)₂)—, —C(H)(CH₂CH₂CH₃)—, —C(H)(CH₂CH₂CH₂CH₃)—, —C(H)(C(CH₃)₃)—, —C(H)(CH₂CH₂CH₂CH₂CH₃)—, —C(H)(CH₂C(H)(CH₃)₂)—, —C(H)(C(H)(CH₃)CH₂CH₂CH₃)—, —C(CH₃)(CH₂CH₃)—, C(CH₃)(CH₂CH₂CH₃)—, —C(CH₂CH₃)(CH₂CH₃)—, —C(CH₃)(CH(CH₃)₂)—, —C(CH₃)(C(CH₃)₃)—, —C(CH₂CH₃)(C(H)(CH₃)₂)—, preferably —CH₂—, —C(H)(CH₃)—, —C(CH₃)₂—, —C(H)(CH₂CH₃)—, —C(H)(CH(CH₃)₂)—, more preferably —CH₂—.
   Examples of substituted cycloalkyl include methylcyclopropane, methylcyclopentane, methylcyclohexane, methylcyclopentene, and methylcyclohexene groups, preferably methylcyclopropane, methylcyclopentane and methylcyclohexane groups.
   Examples of substituted or unsubstituted aromatic residue include methoxybenzyl, methylbenzyl, and fluorenyl groups.
   Examples of substituted or unsubstituted heterocycle include furfuryl, picolinyl, pyrimidyl, thienyl, and indolyl groups.

According to one embodiment, the alkyl-substituted aromatic epoxy resin of the general formula (I) has each of R and R₁ independently is methyl, ethyl or isopropyl, each of R₂ and R₃ independently is hydrogen, methyl, ethyl or isopropyl, and X is a linear or branched alkyl having 1 to 6 carbon atoms.

According to one embodiment, the bis alicyclic amine hardener of the general formula (II) has:
each of R₄ and R₅ independently is hydrogen, methyl, ethyl or isopropyl,
each of R₆ and R₇ independently is hydrogen, methyl, ethyl or isopropyl,
Y is —O—, —S—, —CO—, —C(═O)O—, —NHCO—, —SO₂—, a linear or branched alkyl having 1 to 6 carbon atoms, or a substituted or unsubstituted cycloalkyl.

According to one embodiment, the bis alicyclic amine hardener of the general formula (II) has each of R₄ and R₅ independently is hydrogen, methyl, ethyl or isopropyl, each of R6 and R₇ independently is hydrogen, methyl, ethyl or isopropyl, and Y is a linear or branched alkyl having 1 to 6 carbon atoms.

According to one embodiment, the curable epoxy resin composition comprises:
(a) an alkyl-substituted aromatic epoxy resin of the general formula (I), where
   each of R and R₁ independently is methyl, ethyl or isopropyl,
   each of R₂ and R₃ independently is hydrogen, methyl, ethyl or isopropyl,
   X is a linear or branched alkyl having 1 to 6 carbon atoms; and
(b) a bis alicyclic amine hardener of the general formula (II), where
   each of R₄ and R₅ independently is hydrogen, methyl, ethyl or isopropyl,
   each of R₆ and R₇ independently is hydrogen, methyl, ethyl or isopropyl,
   Y is a linear or branched alkyl having 1 to 6 carbon atoms.

In a preferred embodiment, the alkyl-substituted aromatic epoxy resin of the general formula (I) has each of R and R₁ independently is methyl, ethyl or isopropyl, each of R₂ and R₃ independently is hydrogen, methyl, ethyl or isopropyl, and X is —CH₂—.

In a preferred embodiment, the bis alicyclic amine hardener of the general formula (II) has each of R₄ and R₅ independently is hydrogen, methyl, ethyl or isopropyl, each of R₆ and R₇ independently is hydrogen, methyl, ethyl or isopropyl, and Y is —CH₂—.

Advantageously, the curable epoxy resin composition comprises:
(a) an alkyl-substituted aromatic epoxy resin of the general formula (I), where
   each of R and R₁ independently is methyl, ethyl or isopropyl,
   each of R₂ and R₃ independently is hydrogen, methyl, ethyl or isopropyl,
   X is —CH₂—; and
(b) a bis alicyclic amine hardener of the general formula (II), where
   each of R₄ and R₅ independently is hydrogen, methyl, ethyl or isopropyl,
   each of R₆ and R₇ independently is hydrogen, methyl, ethyl or isopropyl,
   Y is —CH₂—.

In another preferred embodiment, the alkyl-substituted aromatic epoxy resin of the general formula (I) has each of R and R₁ is ethyl, each of R₂ and R₃ is hydrogen, and X is —CH₂—.

In another preferred embodiment, the bis alicyclic amine hardener of the general formula (II) has each of R₄ and R₅ independently is hydrogen, methyl or ethyl, each of R₆ and R₇ is hydrogen, and Y is —CH₂—.

More advantageously, the curable epoxy resin composition comprises:
(a) an alkyl-substituted aromatic epoxy resin of the general formula (I), where
   each of R and R₁ is ethyl,
   each of R₂ and R₃ is hydrogen,
   X is —CH₂—; and
(b) a bis alicyclic amine hardener of the general formula (II), where
   each of R₄ and R₅ is hydrogen, methyl or ethyl,
   each of R₆ and R₇ is hydrogen,
   Y is 13 CH₂—.

For example, the alkyl-substituted aromatic epoxy resin of the general formula (I) is N,N,N′,N′-tetraglycidyl-4,4′-diamino-3,3′-diethyldiphenylmethane. The CAS number is 130728-76-6.

N,N,N′,N′-tetraglycidyl-4,4′-diamino-3,3′-diethyldiphenylmethane is commercially available from Huntsman Advanced Materials under the Araldite® brand name.

For example, the bis alicyclic amine hardener of the general formula (II) is 4,4′-Methylenebis(2-methylcyclohexylamine). The CAS number is 6864-37-5. Another example of bis alicyclic amine hardener is 4,4′-methylenebis(cyclohexylamine). The CAS number is 1761-7-3.

4,4′-Methylenebis(2-methylcyclohexylamine) is commercially available from Huntsman Advanced Materials under the Aradur® brand name. 4,4′-methylenebis(cyclohexylamine) is commercially available from BASF under the Dicykan® brand name.

In a preferred embodiment, the curable epoxy resin composition comprises:
from about 5% by weight to about 95% by weight, preferably from about 10% by weight to about 90% by weight, and more preferably from about 15% by weight to about 85% by weight, based on the total weight of the epoxy resin composition, of an alkyl-substituted aromatic epoxy resin of formula (I) as above described, and
from about 5% by weight to about 95% by weight, preferably from about 10% by weight to about 90% by weight, and more preferably from about 15% by weight to about 85% by weight, based on the total weight of the epoxy resin composition, of bis alicyclic amine hardener of formula (II) as above described.

Advantageously, the curable epoxy resin composition comprises:
from about 40% by weight to about 80% by weight, preferably from about 50% by weight to about 80% by weight, and more preferably from about 60% by weight to about 80% by weight, based on the total weight of the epoxy resin composition, of an alkyl-substituted aromatic epoxy resin of formula (I) as above described, and from about 20% by weight to about 60% by weight, preferably from about 20% by weight to about 50% by weight, and more preferably from about 20% by weight to about 40% by weight, based on the total weight of the epoxy resin composition, of bis alicyclic amine hardener of formula (II) as above described.

In one embodiment, the curable epoxy resin composition may optionally comprise catalysts including imidazoles such as 2-methylimidazole; 2-ethyl-4-methylimidazole; 2-phenyl imidazole; tertiary amines such as triethylamine, tripropylamine, N,N-dimethyl-1-phenylmethaneamine and 2,4,6-tris((dimethylamino)methyl)phenol and tributylamine; phosphonium salts such as ethyltriphenylphosphonium chloride, ethyltriphenylphosphonium bromide and ethyltriphenylphosphonium acetate; ammonium salts such as benzyltrimethylammonium chloride and benzyltrimethylammonium hydroxide and mixtures thereof.

If desired, the curable epoxy resin composition may optionally be mixed, before cure, with one or more customary additives, such as, stabilizers, tougheners, extenders, fillers, reinforcing agents, pigments, dyestuffs, plasticizers, tackifiers, accelerators, non-reactive diluents or any mixture thereof.

Stabilizers which may be employed include: phenothiazine itself or C-substituted phenothiazines having 1 to 3 substituents or N-substituted phenothiazines having one substituent for example, 3-methyl-phenothiazine, 3-ethyl-phenothiazine, 10-methyl-phenothiazine; 3-phenyl-phenothiazine, 3,7-diphenyl-phenothiazine; 3-chlorophenothiazine, 2-chlorophenothiazine, 3-bromophenothiazine; 3-nitrophenothiazine, 3-aminophenothiazine, 3,7-diaminophenothiazine; 3-sulfonyl-phenothiazine, 3,7-disulfonyl-phenothiazine, 3,7-dithiocyanatophenthiazin; substituted quinines and catechols, copper naphthenate, zinc-dimethyldithiocarbonate and phosphotungistic acid hydrate. Tougheners, extenders, reinforcing agents, fillers, accelerators and pigments which can be employed include, for example: poly(ether sulfone), nylon, core-shell rubber, phenoxy, coal tar, bitumen, glass fibers, boron fibers, carbon fibers, cellulose, polyethylene powder, polypropylene powder, mica, asbestos, quartz powder, gypsum, antimony trioxide, bentones, silica aerogel (“aerosil”), lithopone, barite, titanium dioxide, eugenol, dicumyl peroxide, isoeugenol, carbon black, graphite, and iron powder. It is also possible to add other additives, for example, flameproofing agents, flow control agents such as silicones, cellulose acetate butyrate, polyvinyl butyrate, waxes, stearates and the like.

The present invention also relates to a process for forming a fiber-reinforced epoxy composite material, comprising:
a) mixing an alkyl-substituted aromatic epoxy resin as above described and a bis alicyclic amine hardener as above described to form a curable epoxy resin composition of the present disclosure;
b) transferring the resulting curable epoxy resin composition into a mold that contains reinforcing fibers;
c) curing the resulting epoxy resin composition in the mold at a conventional cure temperature to form a fiber-reinforced composite material in which the reinforcing fibers are embedded in a polymeric matrix formed by curing the resulting epoxy resin composition; and
d) demolding the fiber-reinforced composite material.

Polymeric matrices are formed from the curable epoxy resin composition of the present disclosure by mixing an alkyl-substituted aromatic epoxy resin and a bis alicyclic amine hardener at proportions as described before and curing the resulting mixture. Either or both of the components can be preheated if desired before they are mixed with each other. The preheating step is often implemented to lower the viscosity of the components in order to achieve thorough mixing of both components in a short period of time. It is generally necessary to heat the mixture to an elevated temperature to obtain a rapid cure. In a molding process such as the process for making molded composite materials described below, the curable epoxy resin composition is introduced into a mold, which may be, together with any reinforcing fibers and/or inserts as may be contained in the mold, preheated. The curing temperature may be, for example from about 90° C. to about 190° C., or from about 100° C. to about 190° C. or from about 110° C. to about 190° C. In still another embodiment the curing temperatures are governed by the onset of reaction as measured by Differential Scanning Calorimetry (DSC). The onset of reaction is defined as the temperature at which the curable system undergoes sufficient exothermic reaction such that less heat is required to maintain the heat flow with respect to a reference. This curing onset temperature may be, for example from about 130° C. to about 190° C. or more preferably from about 140° C. to about 190° C. Onset temperatures above 190° C. are not capable of achieving rapid low temperature curing and temperatures below 120° C. do not allow sufficient time to infuse parts with high quality.

In one embodiment, it is preferred to continue the cure until the resulting polymeric matrix attains a glass transition temperature in excess of the cure temperature. Advantageously, the polymeric matrix attains a glass transition temperature of at least 300° C.

In another embodiment, the glass transition temperature at the time of demolding is preferably at least 130° C., or at least 150° C., or even still at least 180° C. or further at least 200° C. An advantage of this disclosure is that such glass transition temperatures can be obtained with short curing times. This allows for short cycle times.

In one embodiment, the curable epoxy resin composition exhibits a degree of cure of about 85% or higher when cured at the temperatures described before. In yet another embodiment, the curable epoxy resin composition exhibits a degree of cure of about 90% or higher, or 95% or higher, when cured at the temperature described before. In still another embodiment it may be desired to further cure the composite material after demolding in a separate stage, such as in a heated oven, to reach a degree of cure above 90% or even above 95%.

As noted above, the curable epoxy resin composition of the present disclosure is particularly useful for making fiber-reinforced composite materials by curing the system in the presence of reinforcing fibers. According to the present disclosure, these composites are in general made by mixing an alkyl-substituted aromatic epoxy resin as above described and a bis alicyclic amine hardener as above described to form a curable epoxy resin composition, wetting the fibers with the curable epoxy resin composition, and then curing said epoxy resin composition at the temperatures described before in the presence of the reinforcing fibers.

The reinforcing fibers are thermally stable and have a degradation temperature, such that the reinforcing fibers do not degrade or melt during the curing process. Suitable fiber materials may include, for example, glass, quartz, polyamide resins, aramid, boron, carbon, wheat straw, hemp, sisal, cotton, bamboo and gel-spun polyethylene fibers.

The reinforcing fibers can be provided in the form of short (0.5 to 15 cm) fibers, long (greater than 15 cm) fibers or continuous rovings. The fibers can be provided in the form of a mat or other preform if desired, such mats or preforms may in some embodiments be formed by entangling, weaving and/or stitching the fibers, or by binding the fibers together using an adhesive binder. Preforms may approximate the size and shape of the finished composite material (or portion thereof that requires reinforcement). Mats of continuous or shorter fibers can be stacked and pressed together, typically with the aid of a tackifier, to form preforms of various thicknesses, if required.

Suitable tackifiers for preparing preforms include heat-softenable polymers such as described in, for example, U.S. Pat. Nos. 4,992,228, 5,080,851 and 5,698,318. The tackifier should be compatible with and/or react with the polymer phase of the composite so that there is good adhesion between the polymer and reinforcing fibers. The tackifier may contain other components, such as one or more catalysts, a thermoplastic polymer, a rubber, or other modifiers.

A sizing or other useful coating may be applied onto the surface of the fibers before they are introduced into the mold. A sizing often promotes adhesion between the cured resin and the fiber surfaces.

The composite material may be formed in a mold. In such a case, the reinforcing fibers may be introduced into the mold before introducing the curable epoxy resin composition. This is normally the case when a fiber preform is used. The fiber preform is placed into the mold, the mold is closed, and the curable epoxy resin composition is then introduced into the mold where it penetrates between the fibers in the preform, fills the cavity, and then cures to form the composite material.

Alternatively, the fibers (including a preform) can be deposited into an open mold, and the curable epoxy resin composition can be sprayed, poured or injected onto the preform and into the mold. After the mold is filled in this manner, the mold is closed and the said epoxy resin composition cured. An example of a process of this type is gap compression resin transfer molding, in which the mold containing the fibers is kept open with a gap which may be, for example, 10% to 100% or more of the original cavity thickness. The gap permits lower flow resistance, which makes mold filling easier and facilitates penetration of the curable epoxy resin composition around and between the fibers.

Short fibers can be introduced into the mold with the curable epoxy resin composition. Such short fibers may be, for example, blended with the alkyl-substituted aromatic epoxy resin or the bis alicyclic amine hardener (or both) prior to forming the curable epoxy resin composition. Alternatively, the short fibers may be added into the curable epoxy resin composition at the same time as the alkyl-substituted aromatic epoxy resin and the bis alicyclic amine hardener are mixed, or afterward but prior to introducing the curable epoxy resin composition into the mold.

Alternatively, short fibers can be sprayed into a mold. In such cases, the curable epoxy resin composition can also be sprayed into the mold, at the same time or after the short fibers are sprayed in. When the fibers and curable epoxy resin composition are sprayed simultaneously, they can be mixed together prior to spraying. Alternatively, the fibers and curable epoxy resin composition can be sprayed into the mold separately but simultaneously. The sprayed materials may be spread and/or leveled using a doctor blade or similar device before closing the mold and performing the cure. In a process of particular interest, long fibers are chopped into short lengths and the chopped fibers are sprayed into the mold, at the same time as or immediately before the curable epoxy resin composition is sprayed in. Mesh materials often function as flow promoters.

A wet compression process can be used, in which the curable epoxy resin composition is applied directly to a fiber preform or stack without injection by spraying or by laying it down as “bands” of system, which are being fed through a wider slit die, which could have a width of 1 cm to 50 cm or more. Sufficient material is applied to reach the desired fiber volume content in the final composite material. The curable epoxy resin composition can be applied to the fibers inside an open mold, or outside the mold. The curable epoxy resin composition may instead be applied to the center layer of a build-up, by wetting a layer of fibers with the curable epoxy resin composition and then putting a second layer of fibers onto the wetted surface, therefore sandwiching the resin layer in between two layers of fibers. The fiber mats can be made out of non-crimped fiber buildups, of woven fabric, of random fiber build-ups or preforms. If the curable epoxy resin composition is applied to the fibers outside of the mold, it is typically applied at a somewhat low temperature, to prevent premature curing, and to maintain the viscosity of the curable epoxy resin composition so it does not drip off the fibers before they are transferred into the mold. The wetted preform is then placed into the lower half of a hot mold, the mold is closed and the material cured under compression.

Composite materials made in accordance with the present disclosure may have fiber contents of at least 40 volume %, or at least 50 volume %, up to 60 volume %, or even up to 70 volume %.

The mold may contain, in addition to the reinforcing fibers, one or more inserts. Such inserts may function as reinforcements, may function as flow promoters, and in some cases may be present for weight reduction purposes. Examples of such inserts include, for example, wood, plywood, metals, various polymeric materials, which may be foamed or unfoamed, such as polyethylene, polypropylene, another polyolefin, a polyurethane, polystyrene, a polyamide, a polyimide, a polyester, polyvinylchloride and the like, various types of composite materials, and the like, that do not become distorted or degraded at the temperatures encountered during the molding step.

The reinforcing fibers and core material, if any, may be enclosed in a bag or film such as is commonly used in vacuum assisted processes.

The mold and the preform (and any other inserts, if any) may be heated to the curing temperature or some other useful elevated temperature prior to contacting them with the reactive mixture. The mold surface may be treated with an external mold release agent, which may be solvent or water-based.

The particular equipment that is used to mix the alkyl-substituted aromatic epoxy resin and the bis alicyclic amine hardener of the curable epoxy resin composition and transfer the composition to the mold is not considered to be critical to the present disclosure, provided the curable epoxy resin composition can be transferred to the mold before it attains a high viscosity or develops significant amounts of gel. The process of the present disclosure is amenable to RTM, VARTM, RFI, gap compression resin transfer molding and SCRIMP processing methods and equipment (in some cases with equipment modification to provide the requisite heating at the various stages of the process), as well as to other methods such as wet compression.

The mixing apparatus used to mix the epoxy component and curing component can be of any type that can produce a highly homogeneous reactive mixture (and any optional components that are also mixed in at this time). Mechanical mixers and stirrers of various types may be used. Two preferred types of mixers are static mixers and impingement mixers.

In some embodiments, the mixing and dispensing apparatus is an impingement mixer. Mixers of this type are commonly used in so-called reaction injection molding processes to form polyurethane and polyurea moldings. The alkyl-substituted aromatic epoxy resin and the bis alicyclic amine hardener (and other additives which are mixed in at this time) are pumped under pressure into a mixing head where they are rapidly mixed together. Operating pressures in high pressure machines may range from 1,000 to 29,000 psi or higher (6.9 to 200 MPa or higher), although some low pressure machines can operate at significantly lower pressures. The resulting curable epoxy resin composition is then preferably passed through a static mixing device to provide further additional mixing, and then transferred into the mold cavity. The static mixing device may be designed into the mold. This has the advantage of allowing the static mixing device to be opened easily for cleaning.

In certain specific embodiments, the alkyl-substituted aromatic epoxy resin and the bis alicyclic amine hardener are mixed as just described, by pumping them under pressure into a mixing head. Impingement mixing may be used. The operating pressure of the incoming alkyl-substituted aromatic epoxy resin and the bis alicyclic amine hardener streams may range from a somewhat low value (for example, from about 1 to about 6.9 MPa) or a high value (such as, for example, from 6.9 to 200 MPa). The resulting curable epoxy resin composition is then introduced into the mold at a somewhat low operating pressure (such as up to 5 MPa or up to about 1.035 MPa). In such embodiments, the curable epoxy resin composition is typically passed through a static mixer before entering the mold. Some or all of the pressure drop between the mix head and the mold injection port often will take place through such a static mixer. One preferred apparatus for conducting the process is a reaction injection molding machine, such as is commonly used to processes large polyurethane and polyurea moldings.

In other embodiments, the curable epoxy resin composition is mixed as before, and then sprayed into the mold. Temperatures are maintained in the spray zone such that the temperature of the hot curable epoxy resin composition is maintained as described before.

The mold is typically a metal mold, but it may be ceramic or a polymer composite provided the mold is capable of withstanding the pressure and temperature conditions of the molding process. The mold contains one or more inlets, in liquid communication with the mixer(s), through which the reactive mixture is introduced. The mold may contain vents to allow gases to escape as the curable epoxy resin composition is injected.

The mold is typically held in a press or other apparatus which allows it to be opened and closed, and which can apply pressure on the mold to keep it closed during the filling and curing operations. The mold or press is provided with means by which heat or cooling can be provided.

In some embodiments of the foregoing process, the molded composite is demolded in no more than 200 minutes, preferably from 150 to 180 minutes, more preferably from 100 to 150 minutes, after the curable epoxy resin composition has been introduced into the mold. In such processes, the introduced curable epoxy resin composition flows around and between the reinforcing fibers and fills the mold and then cures in the mold, preferably forming a polymer having a glass transition temperature of at least 300° C. within 90 minutes, more preferably within 30 to 60 minutes, after the reactive mixture has been introduced into the mold.

The process of the present disclosure is useful to make a wide variety of composite materials, including various types of aerospace and automotive parts. Examples of the aerospace parts include those described before while the automotive parts include vertical and horizontal body panels, automobile and truck chassis components, and so-called “body-in-white” structural components.

In other embodiments, the curable epoxy resin composition may be used as a coating to form a resin coated substrate, as an adhesive for bonding one or more like or dissimilar substrates together or as an encapsulant to encapsulate electronic components.

### EXAMPLES

Table 1 below depicts cure onset for various curable resin systems as measured by differential scanning calorimetry (DSC) following ASTM E2160 and glass transition temperature by dynamic mechanical analysis (DMA) following ASTM D5418. Comparative examples 1 to 7 are combinations of an alkyl-substituted aromatic epoxy resin with different types of amine hardener. Inventive examples 1 and 2 are combinations of an alkyl-substituted aromatic epoxy resin and a bis alicyclic amine hardener. In Table 1, the epoxy and the amine contents in the composition are expressed in weight percent based on the total weight of said composition. The results for the comparative examples demonstrate that these curable epoxy resins compositions lack of achieving an improved high glass transition temperature when cured with conventional cure temperatures.

TABLE 1

| | | | Comp | Comp | Comp | Comp | Comp | Comp | Comp |
|---|---|---|---|---|---|---|---|---|---|
| | Ex 1 | Ex 2 | 1 | 2 | 3 | 4 | 5 | 6 | 7 |
| Epoxy | | | | | | | | | |
| Araldite ® MY | 68.2 | 70.8 | 65.8 | 59.5 | 55.1 | 67.0 | 57.5 | 62.2 | 73.9 |
| 722 | | | | | | | | | |
| Amines | | | | | | | | | |
| Aradur ® 2954 | 31.8 | | | | | | | | |
| 4,4′- | | 29.2 | | | | | | | |
| Methylenebis(cyclo- | | | | | | | | | |
| hexylamine) | | | | | | | | | |
| DAPI | | | 34.2 | | | | | | |
| 4,4′-(9- | | | | 40.5 | | | | | |
| Fluorenylidene)dianiline | | | | | | | | | |
| 9,9-Bis(4- | | | | | 44.9 | | | | |
| amino-3- | | | | | | | | | |
| chlorophenyl)fluorene | | | | | | | | | |
| 4,4′-DDS | | | | | | 33.0 | | | |
| MCDEA | | | | | | | 42.5 | | |
| M-MIPA | | | | | | | | 37.8 | |
| Aradur ® 5200 | | | | | | | | | 26.1 |
| Stoich. | 0.99 | 1.00 | 1.00 | 1.00 | 1.00 | 1.00 | 1.00 | 0.99 | 1.00 |
| (Amine/Epoxy) | | | | | | | | | |
| Onset, ° C. | 143 | 135 | 186 | 203 | 263 | 226 | 306 | 252 | 223 |
| Peak, ° C. | 187 | 167 | 221 | 233 | 307 | 264 | X | 288 | 265 |
| Cure Schedule | A | B | A | A | A | A | A | A | A |
| Gelled* | Yes | Yes | Yes | Yes | No | Yes | No | Yes | Yes |
| DMA Tg, ° C. | 318 | 315 | 224 | 219 | X | 210 | X | 148 | 134 |
| Liquid | Yes | Yes | Yes | No | No | No | Yes | Yes | Yes |
| processing | | | | | | | | | |
| VARTM | | | | | | | | | |

| | |
|---|---|
| Cure Schedule A | 30 min at 130° C. then 2 h at 180° C. |
| Cure Schedule B | 1 h at 90° C. then 30 min at 130° C. and then 2 h at 180° C. |

*Note:
Compositions that did not gel could not be tested for Tg
Araldite ® MY 722: N,N,N′,N′-tetraglycidyl-4,4′-diamino-diethyldiphenylmethane.
Aradur ® 2954: 4,4′-Methylenebis(2-methylcyclohexylamine)
DAPI: 5(6)-amino-3-(4′-aminophenyl)-1,1,3-trimethylindane
4,4′-DDS: 4,4′-diaminodiphenylsulfone
MCDEA: 4,4′-methylenebis(3-chloro-2,6-diethylaniline)
M-MIPA: 4,4′-Methylenebis(2-isopropyl-6-methylaniline)
Aradur ® 5200: Low viscosity, non-MDA based liquid aromatic diamine

Although making and using various embodiments of the present disclosure have been described in detail above, it should be appreciated that the present disclosure provides many applicable inventive concepts that can be embodied in a wide variety of specific contexts. The specific embodiments discussed herein are merely illustrative of specific ways to make and use the invention, and do not delimit the scope of the invention.

What is claimed is:

1. A curable epoxy resin composition comprising:
(a) an alkyl-substituted aromatic epoxy resin of the general formula (I): 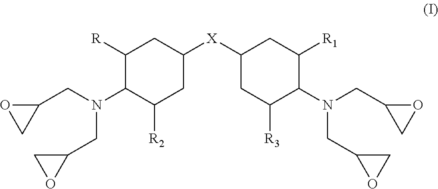
where
each of R and R₁ independently is methyl, ethyl or isopropyl,
each of R₂ and R₃ independently is hydrogen, methyl, ethyl or isopropyl,
X is —O—, —S—, —CO—, —C(═O)O—, —NHCO—, —SO₂—, a linear or branched alkyl, a substituted or unsubstituted cycloalkyl, a substituted or unsubstituted aromatic residue, or a substituted or unsubstituted heterocycle; and
(b) a bis alicyclic amine hardener of the general formula (II): 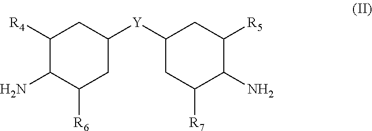
where
each of R₄ and R₅ independently is hydrogen, methyl, ethyl or isopropyl,
each of R₆ and R₇ independently is hydrogen, methyl, ethyl or isopropyl,
Y is —O—, —S—, —CO—, —C(═O)O—, —NHCO—, —SO₂—, a linear or branched alkyl or a substituted or unsubstituted cycloalkyl.

2. The curable epoxy resin composition of claim 1, wherein the alkyl-substituted aromatic epoxy resin of the general formula (I) has each of R and R₁ independently is methyl, ethyl or isopropyl, each of R₂ and R₃ independently is hydrogen, methyl, ethyl or isopropyl, and X is —O—, —S—, —CO—, —C(═O)O—, —NHCO—, —SO₂—, a linear or branched alkyl having 1 to 6 carbon atoms, a substituted or unsubstituted cycloalkyl, a substituted or unsubstituted aromatic residue, or a substituted or unsubstituted heterocycle.

3. The curable epoxy resin composition of claim 1, wherein the alkyl-substituted aromatic epoxy resin of the general formula (I) has each of R and R₁ independently is methyl, ethyl or isopropyl, each of R₂ and R₃ independently is hydrogen, methyl, ethyl or isopropyl, and X is a linear or branched alkyl having 1 to 6 carbon atoms.

4. The curable epoxy resin composition of claim 1, wherein the alkyl-substituted aromatic epoxy resin of the general formula (I) has each of R and R₁ independently is methyl, ethyl or isopropyl, each of R₂ and R₃ independently is hydrogen, methyl, ethyl or isopropyl, and X is —CH₂—.

5. The curable epoxy resin composition of claim 1, wherein the alkyl-substituted aromatic epoxy resin of the general formula (I) has each of R and R₁ is ethyl, each of R₂ and R₃ is hydrogen, and X is —CH₂—.

6. The curable epoxy resin composition of claim 1, wherein the bis alicyclic amine hardener of the general formula (II) has each of R₄ and R₅ independently is hydrogen, methyl, ethyl or isopropyl, each of R₆ and R₇ independently is hydrogen, methyl, ethyl or isopropyl, and Y is —O—, —S—, —CO—, —C(═O)O—, —NHCO—, —SO₂—, a linear or branched alkyl having 1 to 6 carbon atoms or a substituted or unsubstituted cycloalkyl.

7. The curable epoxy resin composition of claim 1, wherein the bis alicyclic amine hardener of the general formula (II) has each of R₄ and R₅ independently is hydrogen, methyl, ethyl or isopropyl, each of R₆ and R₇ independently is hydrogen, methyl, ethyl or isopropyl, and Y is a linear or branched alkyl having 1 to 6 carbon atoms.

8. The curable epoxy resin composition of claim 1, wherein the bis alicyclic amine hardener of the general formula (II) has each of R₄ and R₅ independently is hydrogen, methyl, ethyl or isopropyl, each of R₆ and R₇ independently is hydrogen, methyl, ethyl or isopropyl, and Y is —CH₂—.

9. The curable epoxy resin composition of claim 1, wherein the bis alicyclic amine hardener of the general formula (II) has each of R₄ and R₅ independently is hydrogen, methyl or ethyl, each of R₆ and R₇ is hydrogen, and Y is—CH₂—.

10. The curable epoxy resin composition of claim 1, wherein the curable epoxy resin composition comprises:
from about 5% by weight to about 95% by weight, preferably from about 10% by weight to about 90% by weight, and more preferably from about 15% by weight to about 85% by weight, based on the total weight of the epoxy resin composition, of an alkyl-substituted aromatic epoxy resin of formula (I) according to claim 1, and
from about 5% by weight to about 95% by weight, preferably from about 10% by weight to about 90% by weight, and more preferably from about 15% by weight to about 85% by weight, based on the total weight of the epoxy resin composition, of bis alicyclic amine hardener of formula (II) according to claim 1.

11. The curable epoxy resin composition of claim 1, wherein the curable epoxy resin composition comprises:
from about 40% by weight to about 80% by weight, preferably from about 50% by weight to about 80% by weight, and more preferably from about 60% by weight to about 80% by weight, based on the total weight of the epoxy resin composition, of an alkyl-substituted aromatic epoxy resin of formula (I) according to claim 1, and
from about 20% by weight to about 60% by weight, preferably from about 20% by weight to about 50% by weight, and more preferably from about 20% by weight to about 40% by weight, based on the total weight of the epoxy resin composition, of bis alicyclic amine hardener of formula (II) according to claim 1.

12. The curable epoxy resin composition of claim 1, wherein the curable epoxy resin composition, upon curing at a temperature of between about 130° C. to about 190° C., exhibits a degree of cure of about 80% or higher.

13. A process for forming a fiber-reinforced epoxy composite material, comprising:
a) mixing an alkyl-substituted aromatic epoxy resin and a bis alicyclic amine hardener to form a curable epoxy resin composition;
b) transferring the resulting curable epoxy resin composition into a mold that contains reinforcing fibers;
c) curing the resulting epoxy resin composition in the mold at a conventional cure temperature to form a fiber-reinforced composite material in which the reinforcing fibers are embedded in a polymeric matrix formed by curing the resulting epoxy resin composition; and
d) demolding the fiber-reinforced composite material.

14. A fiber-reinforced composite material produced according to the method of claim 13.
